(19) United States
(12) Patent Application Publication
(10) Pub. No.: US 2017/0337826 A1
(43) Pub. Date: Nov. 23, 2017

(54) Flight Management and Control for Unmanned Aerial Vehicles

(71) Applicant: Intel Corporation, Santa Clara, CA (US)

(72) Inventors: Michael T. Moran, Naas (IE); Justin Lipman, Shanghai (CN); Dana K. Wyss, Albuqerque, NM (US); Gina C. Madrigal, Albuquerque, NM (US); Esther I. Ferguson, Corrales, NM (US); Abran E. Pena, Albuquerque, NM (US)

(73) Assignee: Intel Corporation, Santa Clara, CA (US)

(21) Appl. No.: 15/162,215

(22) Filed: May 23, 2016

(51) Int. Cl. G08G 5/00; G05D 1/00; B64C 39/02

(52) U.S. Cl. CPC G08G 5/0069; G08G 5/006; B64C 39/024; G05D 1/0088; B64C 2201/141

(57) ABSTRACT

A mechanism is described for facilitating flight management and control for unmanned aerial vehicles according to one embodiment. A method of embodiments, as described herein, includes facilitating one or more sensors to detect an exclusion zone, wherein the exclusion zone includes a no-fly zone surrounding an entity including at least one of a real property, a personal property, and an individual; receiving a signal from a broadcast beacon associated with the exclusion zone, wherein the signal includes a warning against entering the exclusion zone based a policy; and automatically preventing a computing device from entering the exclusion zone, wherein preventing includes automatically performing at least one of landing the computing device in a fly zone or pulling or turning the computing device away from the exclusion zone.

### FIELD

Embodiments described herein generally relate to computers. More particularly, embodiments relate to facilitating flight management and control for unmanned aerial vehicles.

### BACKGROUND

Unmanned aerial vehicles (UAVs), such as drones, are becoming increasingly popular. With this increased popularity, drones are also becoming highly invasive and even dangerous. Several local, state, and national governments around the world have legislations restricting drone accesses and movements; however, conventional techniques are incapable of timely and accurately controlling a drone's access or movement.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a drone control and security mechanism according to one embodiment.

FIG. 2 illustrates a drone control and security mechanism according to one embodiment.

FIG. 3A illustrates a use-case scenario according to one embodiment.

FIG. 3B illustrates a use-case scenario according to one embodiment.

FIG. 3C illustrates a use-case scenario according to one embodiment.

FIG. 4 illustrates a method for ensuring flight management and control for drones according to one embodiment.

FIG. 5 illustrates computer environment suitable for implementing embodiments of the present disclosure according to one embodiment.

FIG. 6 illustrates a method for facilitating dynamic targeting of users and communicating of message according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel technique for offering automatic and dynamic control over drones in terms of their accesses and movements such that their usage is in compliance with any current and/or emerging government laws, public policies, private preferences, and/or rules, etc. Further, this novel technique offers increased privacy and safety for users and/or properties. For example, in some embodiments, drones may be automatically partially or fully restricted from flying near or within certain exclusion zones, such as public or emergency zones (e.g., hospitals, public gatherings, schools, etc.), secured government zones (e.g., government buildings, diplomatic enclaves, government events, airports, train stations, etc.), private properties (e.g., private homes, business properties, private parties or events, etc.), individual zones (e.g., celebrities, private persons, etc.), and/or the like.

In one embodiment, any number and type of features to support identification and control of drones for privacy and exclusion may be employed at the drone and/or implemented through a service provider's one or more computing devices, such as server computers. For example, one or more of such features may be triggered by one or more broadcast beacons associated with properties and/or users associated with the properties, etc., where a user may carry or wear a wearable broadcast beacon, while a property may host one or more fixed broadcast beacons. In one embodiment, a drone may encounter a signal from a broadcast beacon, where the signal may be used to warn the drone of an approaching exclusion zone when the drone is within a proximate distance of the exclusion zone such that upon receiving the signal, the drone may be allowed to land safely outside the exclusion zone, return to its base, or change course to avoid the beacon's exclusion zone.

It is contemplated and to be noted that embodiments are not limited to any particular number and type of powered devices, unpowered objects, software applications, application services, customized settings, etc., or any particular number and type of computing devices, networks, deployment details, etc.; however, for the sake of brevity, clarity, and ease of understanding, throughout this document, references are made to various sensors, cameras, microphones, speakers, display screens, user interfaces, software applications, user preferences, customized settings, mobile computers (e.g., smartphones, tablet computers, etc.), communication medium/network (e.g., cloud network, the Internet, proximity network, Bluetooth, etc.), but that embodiments are not limited as such.

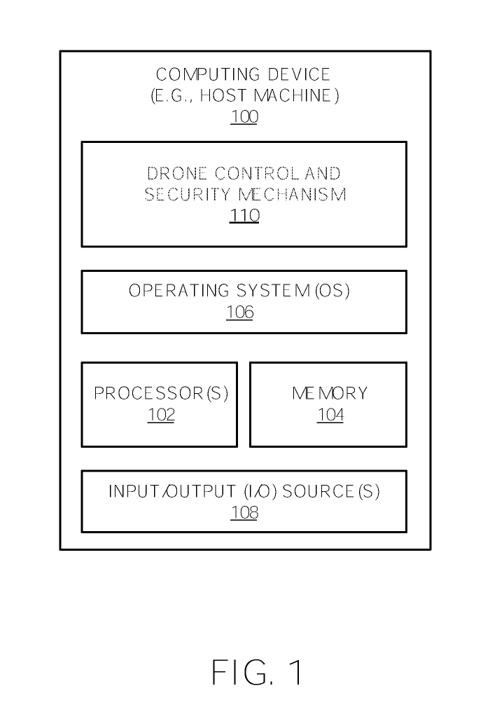

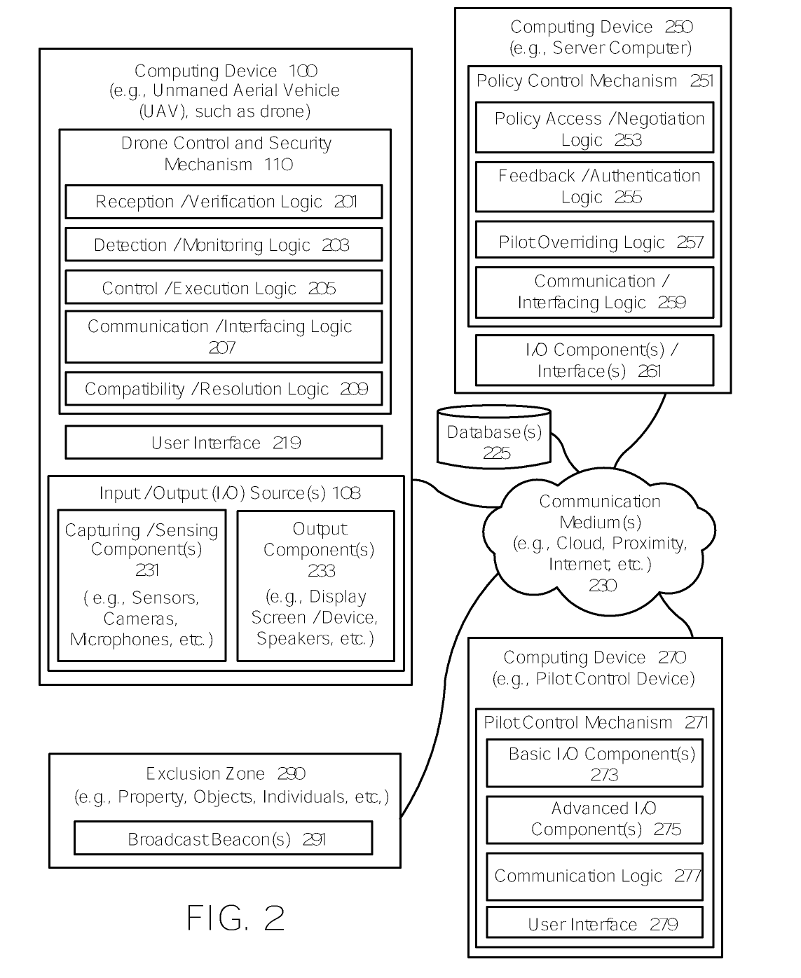

FIG. 1 illustrates a computing device 100 employing a drone control and security mechanism (“drone mechanism”) 110 according to one embodiment. Computing device 100 (such as a drone) serves as a host machine for hosting drone mechanism 110 that includes any number and type of components, as illustrated in FIG. 2, to facilitate one or more dynamic and automatic measures to smartly control computing device 100 while offering security to users (e.g., individuals, governments, private entities, public organizations, etc.) for their selves (such as a user's own person or body) and properties (e.g., private homes, private or public lands, airports, government buildings, parks, libraries, shops, malls, etc.), and/or the like, as will be further described throughout this document.

Computing device 100 may include any number and type of aerial vehicles, such as drones, planes, etc., and although embodiments are not limited to any particular type or number of such aerial vehicles, for the sake of brevity and clarity, most of the discussion in this document focuses on UAVs, such as drones, flying robots, etc., but that embodiments are not limited as such. For example, computing device 100 may include personal drones, commercial drones, military drones, etc.

Computing device 100 may include any number and type of data processing devices/technologies or be in communication with other data processing devices, such as computing device 250 of FIG. 2, including large computing systems, such as server computers, desktop computers, etc., and may further include set-top boxes (e.g., Internet-based cable television set-top boxes, etc.), global positioning system (GPS)-based devices, etc. Computing device 100 may include any number and type of mobile computing devices/technologies or be in communication with other mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, HMDs (e.g., wearable glasses, head-mounted binoculars, gaming displays, military headwear, etc.), and other wearable devices (e.g., smartwatches, bracelets, smartcards, jewelry, clothing items, etc.), Internet of Things (IoT) devices, and/or the like.

Computing device 100 may include an operating system (OS) 106 serving as an interface between hardware and/or physical resources of the computer device 100 and a user. Computing device 100 further includes one or more processor(s) 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a person or a group of individuals or persons using or having access to one or more computing devices, such as computing device 100.

FIG. 2 illustrates drone mechanism 110 of FIG. 1 according to one embodiment. In one embodiment, drone mechanism 110 may include any number and type of components, such as (without limitation): reception/verification logic 201; detection/monitoring logic 203; control/execution logic 205; communication/interfacing logic 207; and compatibility/resolution logic 209.

Computing device 100 is further shown to include user interface 219 (e.g., graphical user interface (GUI)-based user interface, Web browser, cloud-based platform user interface, software application-based user interface, other user or application programming interfaces (APIs) etc.), as facilitated by communication/interfacing logic 207. Computing device 100 may further include I/O source(s) 108 having capturing/sensing component(s) 231 and output component(s) 233.

Computing device 100 is further illustrated as having access to and/or being in communication with one or more database(s) 225 and/or one or more of other computing devices (e.g., service provider's server computer 250, pilot's control device 270, etc.) over one or more communication medium(s) 230 (e.g., networks such as a cloud network, a proximity network, the Internet, etc.). Further, in one embodiment, drone mechanism 110 may be hosted entirely at and by computing device 100. In another embodiment, one or more components of drone mechanism 110 may be hosted at and by another computing device, such as a server computer 250.

In some embodiments, database(s) 225 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, computing device 100 may host I/O sources 108 including capturing/sensing component(s) 231 and output component(s) 233. In one embodiment, capturing/sensing components 231 may include sensor array (such as microphones or microphone array (e.g., ultrasound microphones), cameras or camera array (e.g., two-dimensional (2D) cameras, three-dimensional (3D) cameras, infrared (IR) cameras, depth-sensing cameras, etc.), capacitors, radio components, radar components, etc.), scanners, accelerometers, etc. Similarly, output component(s) 233 may include any number and type of display devices or screens, projectors, speakers, light-emitting diodes (LEDs), one or more speakers and/or vibration motors, etc.

As illustrated, in one embodiment, computing device 100 may be coupled to one or more other computing devices, such as computing device 250, to provide or facilitate additional services or tasks relating to computing device 100. For example, computing device 250 may be a server computer hosting policy and negotiations control mechanism (“policy control mechanism”) 251 to offer one or more services or tasks relating to policy-based maneuvering of computing device 100, negotiating with respective authorities (e.g., government, property owners, individuals, etc.), handling feedback to and from beacon(s) 291, overriding pilots (such as steering computing device 100 in a particular direction regardless of its directional settings or wishes of the operator/user in control of computing device 270), and/or the like. For example, policy mechanism 251 may include (without limitation): policy access/negotiation logic 253; feedback/authentication logic 255; pilot overriding logic 257; and communication/interfacing logic 259. Computing device 250 may further include I/O component(s)/interface(s) 261 for not only allowing communication with a user of computing device 250, but also between devices (e.g., computing devices 100 and database(s) 225), mechanisms (e.g., drone mechanism 110 and policy control mechanism 251), and various hardware and/or software components, and/or the like.

Similarly, as illustrated, in one embodiment, computing device 100 may be coupled to one or more other computing devices, such as computing device 270, serving as a pilot control device for a user (e.g., pilot, operator, owner, etc.) of computing device 100. For example, computing device 270 may host pilot control mechanism 271 having one or more basic I/O control component(s) 273 (e.g., keyboard, joystick, display screen, etc.) to control and maneuver computing device 100. In some embodiments, such as in case of commercial or military drones, control mechanism 271 may also include advanced I/O control component(s) 275 serving as additional components to facilitate militaristic and/or commercial tasks, such as firing missiles, prying or spying on opponents, delivering products at destinations, taking photographs, detecting weather changes, etc. As aforementioned, it is contemplated that computing device 100 is not limited to any particular type or number of drones or other UAVs and that it may include any range of such devices, such as personal drones, commercial drones, military drones, etc. In one embodiment, pilot control mechanism 271 may further include communication logic 277 to facilitate communication between computing devices and/or applications along with offering user interface 279. As illustrated, computing device 270 may be in communication, as facilitated by communication logic 277, with computing device 100 and/or computing 250 over one or more communication medium(s) 230.

As previously described, broadcast beacon(s) 291 may include fixed beacons placed at locations, such as open lands, airports, other real properties, etc., and/or wearable or mobile beacons capable of being carried by or installed on a person or a moving object, such as a vehicle, a personal property, etc. These beacon(s) 291 are capable of communicating by emitting signals or messages that can be received by reception/verification logic 201 of drone mechanism 110 at computing device 100. For example, when computing device 100 approaches a physical area, such as exclusion zone 290, one or more beacon(s) 291 may emit a signal to computing device 100 indicating, for example, the area being exclusion zone 290 and thus relevant policies ought to be obeyed by keeping computing device 100 away from exclusion zone 290. In some embodiments, the authenticity of computing device 100 and/or beacon(s) 291 may be verified using reception/verification logic 201, such as by communicating credentials or keys or other identifying information for verification purposes. Further, along with or instead of the signal, reception/verification logic 201 may be capable of receiving any broadcast messages, such as a textual message, an audio and/or video message, etc., from beacon(s) 291 associated with exclusion zone 290, such as any one or more of physical areas, bodies of water, parks, buildings, monuments, schools, public events, concerts, real properties, personal properties, objects, humans, animals, plants, and/or the like.

Similarly, in one embodiment, detection/monitoring logic 203 may be used to continuously or periodically (e.g., over predefined periods of time) or on-demand (e.g., upon occurrence of one or more events, such as arriving in or near a pre-defined area, etc.) facilitate one or more sensors of capturing/sensing component(s) 231 to monitor or track broadcast beacon(s) 291 that are predefined or within a proximate range of computing device 100.

In one embodiment, upon receiving a signal from beacon(s) 291, control/execution logic 205 may be triggered to automatically ensure that computing device 100 stays away from the exclusion or protected zone such that control/execution logic 205 may facilitate computing device 100 to automatically land safely, return to base, or pull back and change course to avoid exclusion zone 290 associated with beacon(s) 291. This way, for example, computing device 100 and its usage is kept aligned or in compliance with any applicable or emerging legislation, government policies, personal preferences, etc., to ensure its safe usage and application. As described throughout this document, it is contemplated that control/execution logic 205 is fully capable of making its own decision on behalf of computing device 100, including automatically performing its tasks, such as keeping computing device 100 from exclusion zone 290, without any influence, instruction, control, or trigger from any user (e.g., users of computing device 100), device (e.g., computing device 250, computing device 270), mechanism or logic (e.g., pilot overriding logic 257 of computing device 250, pilot control mechanism 271 of computing device 270), and/or the like.

In one embodiment, control/execution logic 205 may automatically and directly negotiate with beacon(s) 291 or any other relevant computing devices that incorporate respective beacon handshake and communication exclusion zone protocols. Similarly, in another embodiment, control/execution logic 205 may facilitate policy access/negotiation logic 253 of policy control mechanism 251 of computing device 250 to perform such negotiations on behalf of computing device. In some embodiments, beacon(s) 291 or one or more computing devices associated with beacon(s) 291 may be fully capable of performing handshaking or communicating certain protocols relating to exclusion zone 290 and any policies associated with exclusion zone 290 to negotiate through control/execution logic 205 and/or policy access/negotiation logic 253 in disagreeing or agreeing upon allowing computing device 100 to fly through or land in exclusion zone 290 without any restrictions or with certain restrictions or conditions.

Moreover, control/execution logic 205 and/or policy access/negotiation logic 253 may be capable of automatically accessing and retrieving any policies (e.g., governmental laws or regulations, organizational rules, personal user preferences, etc.) at database(s) 225 to be able to negotiate these policies with beacon(s) 291 and/or relevant computing devices to allow computing device 100 to enter exclusion zone 290 with none or minimal restrictions or, in some embodiments, keeping computing device 100 away from exclusion zone 290, or, in yet some other embodiments, ensuring a safe exit of computing device 100 from exclusion zone 290 upon accidentally or unintentionally entering exclusion zone 290 with permission or negotiations. In one embodiment, control/execution logic 205 and/or pilot overriding logic 257 and/or, in some cases, basic I/O components 273 may be used to keep computing device 100 in the fly zone and away from exclusion zone 290 by pulling back or turning away and choosing an alternate flight path or returning to base or, in some embodiments, achieving a controlled descent leading to safe landing. It is contemplated that in some embodiments, pilot overriding logic 257 is fully capable of automatically performing its tasks, such as keeping computing device 100 from exclusion zone 290, including overriding instructions from any user (e.g., users of computing device 100, devices (e.g., computing device 100, computing device 270), or mechanism or logic (e.g., control/execution logic 205 of computing device 100, pilot control mechanism 271 of computing device 270), and/or the like.

Referring back to negotiations, for example, as a result of successful negotiations, computing device 100 having a camera that is capable of taking pictures or videos may be allowed to enter exclusion zone 290 with a restriction or condition that computing device 100 may refrain from using the camera while flying through exclusion zone 290. Similarly, in some embodiments, successful negotiations may lead to conditional or even unconditional flying of computing device 100 through exclusion zone 290, landing privileges for computing device 100 in exclusion zone 290, safe exit of computing device 100 from exclusion zone 290, and/or the like.

In one embodiment, communication/interfacing logic 207 and/or communication/interfacing logic 259 may be used to ensure a continuous communication between computing device 100, computing device 250, and beacon(s) 291 and/or other relevant computing devices associated with exclusion zone 290, etc., such that feedback/authentication logic 255 may be used to authenticate computing device 250 to beacon(s) 291 and vice versa and receive any feedback or communication from beacon(s) 291, which may then be communicated on to reception/verification logic 201 of drone mechanism 110 at computing device 100. Similarly, in another embodiment, this communication with beacon(s) 291 may be performed directly by reception/verification logic 201, as facilitated by communication/interfacing logic 207, to receive from or provide feedback to beacon(s) 291 and perform any authentication tasks to verify computing device 100 and/or beacon(s) 291, etc., before proceeding with further communication, such as negotiations.

As previously described, a drone, such as computing device 100, may employ its own automatic controls for flying, landing, and other maneuvering or, in some embodiments, it may be controlled through pilot control mechanism 271 of a pilot control device, such as computing device 270, as communicated through communication logic 277 and/or communication/interfacing logic 207. In some embodiments, such as when an immediate or overwhelming control is necessitated or preferred, pilot overriding logic 271 may be triggered to navigate computing device 100 into performing one or more tasks, such as pull back from exclusion zone 290 (e.g., airport), land immediately and safely away from or outside of exclusion zone 290, turn away and return to base, accept and take an alternate route, and/or enter the exclusion under a stated policy or as negotiated.

It is contemplated that the negotiation process is not limited in any way, such as it may further enable the inclusion of additional contact data, a defined geodetic map zone, flight regulations (e.g., drone and/or operator identity, height, speed, landing zones, etc.), and/or the like, that are typically associated with drone flights and/or operators of drones, such as computing device 100 being operated by an operator through computing device 270.

As aforementioned, exclusion zone 290 may not only be defined by fixed of beacon(s) 291 for fixed physical areas, real properties, government buildings, prisons, parks, schools, etc., but that beacon(s) 291 may also include wearable or portable beacons that can be carried by persons or one or more objects or devices, such as a personal property, a smartphone, a bracelet, a door, a clothing item, a wrist strap, etc., which may be used to ensure drone-free personal privacy for families and/or celebrities, such as athletes, actors, politicians, etc. In one embodiment, exclusion zone 290 may include a physical area, a real property, a building, a stadium, etc., while, in another embodiment, exclusion zone 290 may include or be defined as a personal space around a person or an area, such as a home, an office, a recreational area, etc. This is applicable to a personal space being identified by a person with a wearable beacon of beacon(s) 291 that is capable of communicating their desire or preference to be in a drone-free space, such as exclusion zone 290, such as kids playing at a beach or in a pool area, or simply an individual sitting or walking while surrounded and protected by this personal space defined as exclusion zone 290.

In one embodiment, beacon-based exclusion zones, such as exclusion zone 290, may be enabled by one or more techniques, such as proximity ranging (e.g., radial distance from a point beacon), emerging Time of Flight (ToF) ranging, etc., being regarded as appropriate technologies for enabling beacon-based exclusion zones. Further, for example, such technologies may be combined with other techniques, such as global positioning system (GPS)-based locations, for defining geodetic exclusion zones, while various protocols, such as beacon-based exclusion zone communication protocols, may be used to share constraints with drones, such as computing device 100, and their operators having accessing to operating devices, such as computing devices 250, 270.

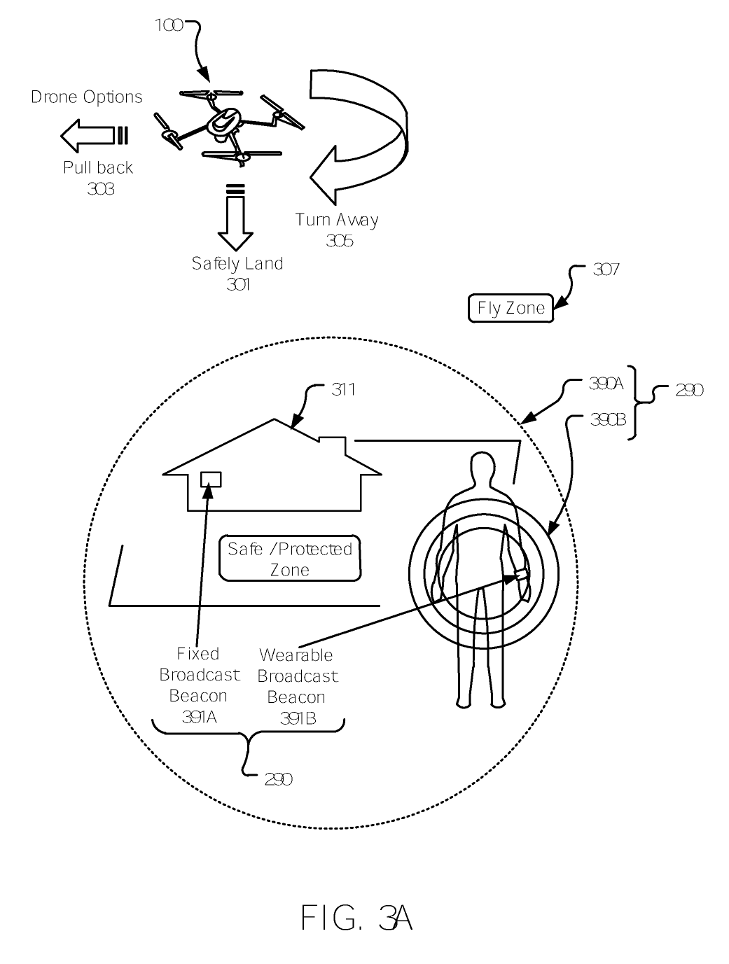

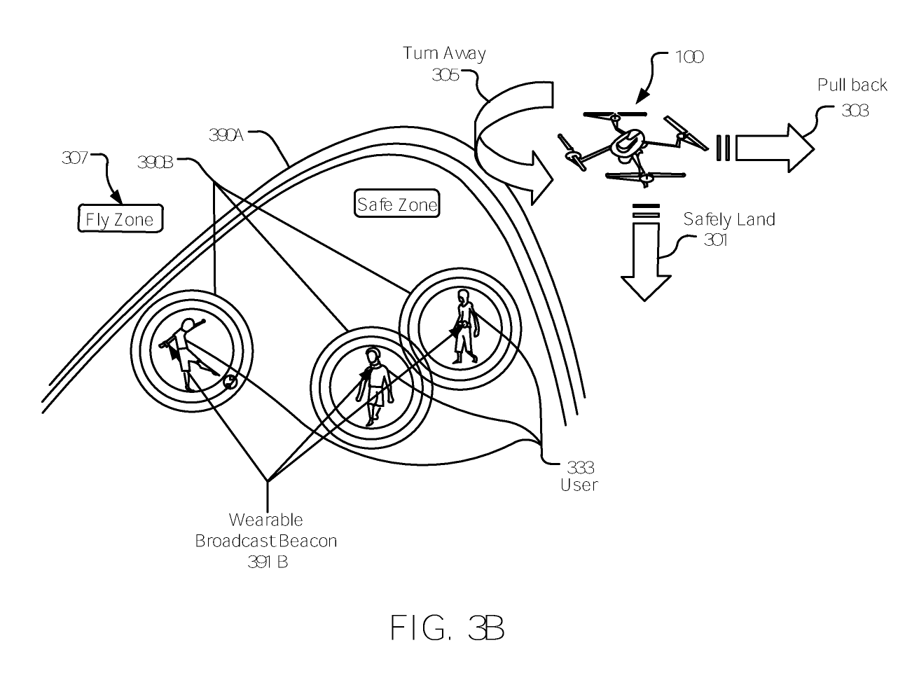

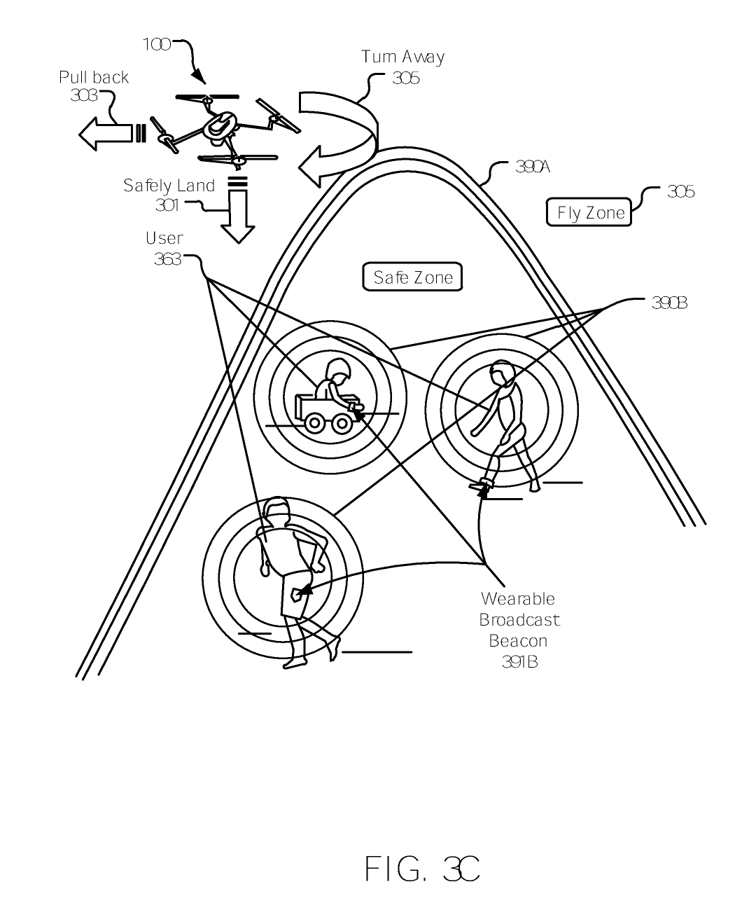

As will be illustrated with reference to FIGS. 3A-3C, some exclusion zones (such as airports, government buildings, schools, prisons, etc.) may be registered with relevant government authorities, while other more ad hoc exclusion zones (such as personal space surrounding an individual or a house, etc.) may be created as desired or necessitated by private individuals or organizations to ensure added safety, security, and privacy for individuals and the public at large.

In one embodiment, computing device 100 may be tagged (such as a marketing label on the box of computing device 100) with a seal stating and authenticating that computing device 100 is entirely in compliance with any governmental laws and other regulations and policies relating to aerial vehicles, including drones, so as to differentiate computing device 100 from all other aerial vehicles which may not be fully in compliance. This allows for the consumers to be certain that the project, such as computing device 100, they are getting is fully conforming and compliant.

Capturing/sensing components 231 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing component(s) 231 may further include one or more of supporting or supplemental devices for capturing and/or sensing of data, such as illuminators (e.g., IR illuminator), light fixtures, generators, sound blockers, etc.

It is further contemplated that in one embodiment, capturing/sensing component(s) 231 may further include any number and type of context sensors (e.g., linear accelerometer) for sensing or detecting any number and type of contexts (e.g., estimating horizon, linear acceleration, etc., relating to a mobile computing device, etc.). For example, capturing/sensing component(s) 231 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Further, for example, capturing/sensing component(s) 231 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.); biometric sensors (such as to detect fingerprints, etc.), calendar maintenance and reading device), etc.; global positioning system (GPS) sensors; resource requestor; and/or TEE logic. TEE logic may be employed separately or be part of resource requestor and/or an I/O subsystem, etc. Capturing/sensing component(s) 231 may further include voice recognition devices, photo recognition devices, facial and other body recognition components, voice-to-text conversion components, etc.

Similarly, output component(s) 233 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) 233 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any particular number or type of use-case scenarios, architectural placements, or component setups; however, for the sake of brevity and clarity, illustrations and descriptions with respect FIGS. 3B-3C are offered and discussed throughout this document for exemplary purposes but that embodiments are not limited as such. Further, throughout this document, “user” may refer to someone having access to one or more computing devices, such as computing device 100, and may be referenced interchangeably with “person”, “individual”, “human”, “him”, “her”, “child”, “adult”, “viewer”, “player”, “gamer”, “developer”, programmer”, and/or the like.

Compatibility/resolution logic 209 may be used to facilitate dynamic communication and compatibility between various components, networks, computing devices, etc., such as computing devices 100, 250, 270, beacon(s) 291, database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and/or the like, may be referenced interchangeably and include, by way of example, software, hardware, and/or any combination of software and hardware, such as firmware. In one example, “logic” may refer to or include a software component that is capable of working with one or more of an operating system, a graphics driver, etc., of a computing device, such as computing device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

Further, any use of a particular brand, word, term, phrase, name, and/or acronym, such as “drone”, “unmanned aerial vehicle”, “exclusion zone”, “safe area”, “protected zone”, “beacon”, “fixed beacon”, “wearable beacon”, “automatic”, “dynamic”, “user interface”, “camera”, “sensor”, “microphone”, “display screen”, “speaker”, “verification”, “authentication”, “privacy”, “user”, “user profile”, “user preference”, “sender”, “receiver”, “personal device”, “smart device”, “mobile computer”, “wearable device”, “IoT device”, “proximity network”, “cloud network”, “server computer”, etc., should not be read to limit embodiments to software or devices that carry that label in products or in literature external to this document.

It is contemplated that any number and type of components may be added to and/or removed from drone mechanism 110 to facilitate various embodiments including adding, removing, and/or enhancing certain features. For brevity, clarity, and ease of understanding of drone mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates a use-case scenario 300 according to one embodiment. As an initial matter, for brevity, many of the details discussed with reference to the previous FIGS. 1-2 may not be discussed or repeated hereafter. Further, it is contemplated and to be noted that embodiments are not limited to any particular number or type of architectural placements, component setups, processes, and/or use-case scenarios, etc., such as use-case scenario 300.

In the illustrated embodiment, computing device 100 (referenced here as “drone”) is shown as flying near areas regarded as exclusion zones 390A and 390B that are the same as or similar to and collectively referenced as exclusion zone 290 of FIG. 2. As illustrated, in one embodiment, broadcast beacons 291 of FIG. 2 may include fixed beacons, such as beacon 391A installed at house 311, and/or moveable beacons, such as wearable beacon 391B being carried by user 313. Both beacons 391A, 391B help create corresponding exclusion zones 390A, 390B spread over a certain area. For example, exclusion zone 390B may cover area surrounding the person of user 313, while exclusion zone 390A may cover area surrounding the real property of house 311. It is contemplated that some of the areas of exclusion zones 390A, 390B may overlap, such as when user 313 is home 311, some or all of exclusion zone 390B is likely to be covered by exclusion zone 390A.

It is further illustrated that the space or area outside exclusion zones 390A and/or 390B is regarded as fly zone 307 where drone 100 can fly and perform various tasks without any restrictions or limitations. However, as drone 100 approaches near one or more of exclusion zones 390A, 390B, drone mechanism 110 along with policy control mechanism 251 may be triggered to, in one embodiment, either negotiate with beacons 391A and/or 391B, respectively, as facilitated by control/execution logic 205 and/or policy access/negotiation logic 253, to obtain at least a restricted flying or landing entry into one or more of exclusion zones 390A, 390B. In another embodiment, drone 100 may simply land safely 301 outside exclusion zones 390A and/or 390B or pull back 303 or turn away 305 to keep in fly zone 307 or return to its base as facilitated by one or more of control/execution logic 205 of FIG. 2 at drone 100, pilot overriding logic 257 at computing device 250 (such as a service provider's server computer) of FIG. 2, and/or pilot control mechanism 271 at computing device 270 (such as a user/operator's pilot control device) of FIG. 2.

In one embodiment, control/execution logic 205 may be triggered with drone 100 is within a proximate distance of exclusion zones 390A, 390B to ensure that drone 100 remains in control and at least one of safe landing 301, pulling back 303, or turning away 305 is appropriately chosen so that privacy expected by users, such as user 313, associated with exclusion zones 390A, 390B is ensured, while keeping drone 100 safe and intact and in compliance with any applicable laws, rules, policies, preferences, etc. In one embodiment, the proximate distance may be defined in laws, policies, user preferences, etc., that are stored and accessible at database(s) 225 of FIG. 2, where this proximate distance and any other conditions may be negotiable using policy access/negotiation logic 253 of FIG. 2. In another embodiment, the user or operation of drone 100 may anticipate exclusion zones 390A, 390B and take preventive action to avoid having drone 100 enter into either of exclusion zones 390A and 390B. In yet another embodiment, pilot overriding logic 257 may be triggered when both drone 100 and pilot control device 270 of FIG. 2 fail to address the issue in which case pilot overriding logic 257 can take charge and ensure at least one of safe landing 301, pulling back 303, or turning away 305 of drone 100 to keep it fly zone 307.

FIG. 3B illustrates a use-case scenario 330 according to one embodiment. As an initial matter, for brevity, many of the details discussed with reference to the previous FIGS. 1-3A may not be discussed or repeated hereafter. Further, it is contemplated and to be noted that embodiments are not limited to any particular number or type of architectural placements, component setups, processes, and/or use-case scenarios, etc., such as use-case scenario 330.

As with FIG. 3A, in the illustrated embodiment, drone 100 is shown as flying near exclusion zones 390A, 390B having options of safely landing 301, pulling back 303, or turning away 305 to stay in fly zone 307 and sufficiently away from exclusion zones 390A, 390B. FIG. 3B illustrates a public place, such as a beach, as opposed to a private residence of FIG. 3A; however, as with FIG. 3A, one or more exclusion zones 390A, 390B may be created and/or negotiated using corresponding broadcast beacons, such as wearable beacons 391B. In the illustrated embodiment, each of users 333 is shown as carrying or wearing wearable beacon 391B. In this illustration, fixed beacon 391A of FIG. 3A is not shown; however, it is contemplated that in one embodiment, a fixed beacon, such as fixed beacon 391A of FIG. 3A, may be installed or placed somewhere on or near the beach to generate a bigger exclusion zone 390A or, in another embodiment, exclusion zone 390A may represent or be created as a result of a combination of smaller exclusion zones, such as exclusion zone 390B.

FIG. 3C illustrates a use-case scenario 360 according to one embodiment. As an initial matter, for brevity, many of the details discussed with reference to the previous FIGS. 1-3B may not be discussed or repeated hereafter. Further, it is contemplated and to be noted that embodiments are not limited to any particular number or type of architectural placements, component setups, processes, and/or use-case scenarios, etc., such as use-case scenario 360.

As with FIGS. 3A and 3B, in the illustrated embodiment, drone 100 is shown as flying near exclusion zones 390A, 390B having options of safely landing 301, pulling back 303, or turning away 305 to stay in fly zone 307 and sufficiently away from exclusion zones 390A, 390B. As with FIG. 3B, in this embodiment, one or more exclusion zones 390A, 390B may be created and/or negotiated using corresponding broadcast beacons, such as wearable beacons 391B. In the illustrated embodiment, each of users 363 is shown as carrying or wearing wearable beacon 391B. In this illustration, fixed beacon 391A of FIG. 3A is not shown; however, it is contemplated that in one embodiment, a fixed beacon, such as fixed beacon 391A of FIG. 3A, may be installed or placed somewhere on or near the playing area or park to generate a bigger exclusion zone 390A or, in another embodiment, exclusion zone 390A may represent or be created as a result of a combination of smaller exclusion zones, exclusion zone 390B.

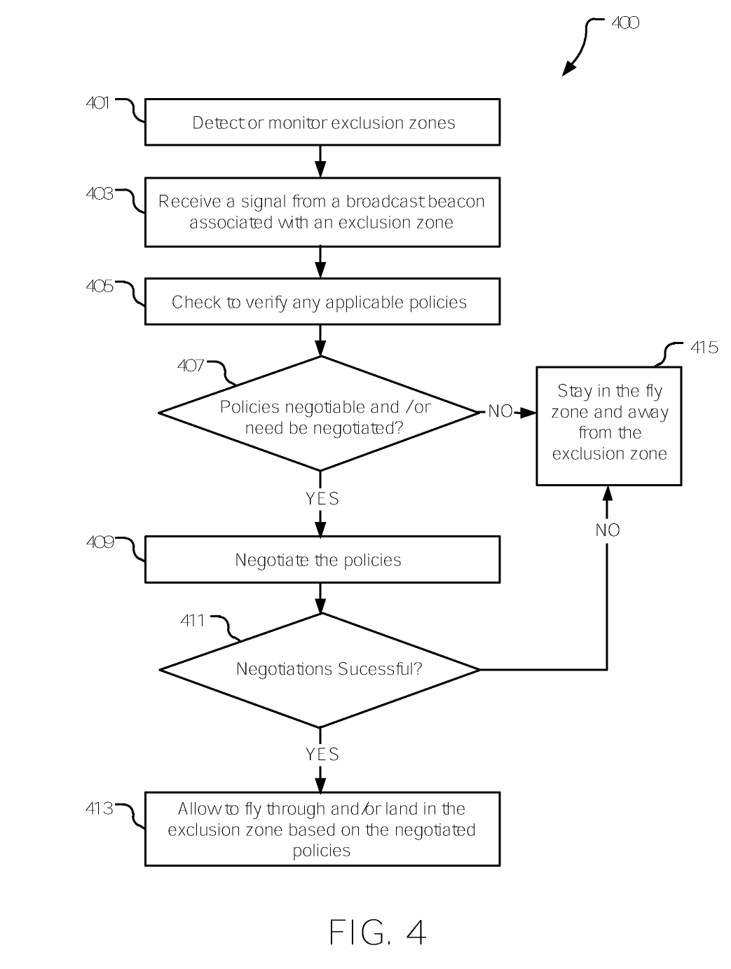

FIG. 4 illustrates a method 400 for ensuring flight management and control for drones according to one embodiment. Method 400 may be performed by processing logic that may comprise hardware (e.g., circuitry, dedicated logic, programmable logic, etc.), software (such as instructions run on a processing device), or a combination thereof, as facilitated by one or more of drone mechanism 110, policy control mechanism 251, and pilot control mechanism 271 FIG. 2. The processes of method 400 are illustrated in linear sequences for brevity and clarity in presentation; however, it is contemplated that any number of them can be performed in parallel, asynchronously, or in different orders. For brevity, many of the details discussed with reference to the previous FIGS. 1-3C may not be discussed or repeated hereafter.

Method 400 begins at block 401 with detection or monitoring, by a drone, of an exclusion zone (e.g., airport, private residence, public park, school, individual, etc.). At block 403, upon having the drone each a predetermined distance from the exclusion zone, a signal is received from a broadcast beacon associated with the exclusion zone, where this signaling may lead to verification or authentication of the drone and/or the exclusion zone and their corresponding users/operators. At block 405, a database repository is checked to verify any applicable policies including any laws, rules, regulations, preferences, etc., relating to this particular exclusion zone.

At block 407, in one embodiment, upon verifying the applicable policies, a determination is made as to whether the policies are negotiable and if they are negotiable, then whether they should be negotiated for this exclusion zone and/or this drone and/or at this time, etc. If yes, the policies are negotiated at block 409. At block 411, another determination is made as to whether the negotiations were successful. If yes, at block 413, the drone may be allowed to fly into or through the exclusion zone based on the negotiated policies, such as under certain conditions, restrictions, etc. If, however, the negotiations are unsuccessful, then, at block 415, the drone may then be controlled to stay in the fly zone and away from the exclusion zone by safely landing in the fly zone or turning away or pulling back from the exclusion zone to detour into an alternate flying path or return back to its base. Similarly, referring back to block 407, if the policies are not negotiable or if they are negotiable, but that they are chosen not to be negotiated for any number of reasons (such as not for this drone or exclusion zone or at this particular time, etc.), then method 400 continues at block 415 with the drone being controlled to stay in the fly zone and away from the exclusion zone by safely landing in the fly zone or turning away or pulling back from the exclusion zone to detour into an alternate flying plan or return back to its base.

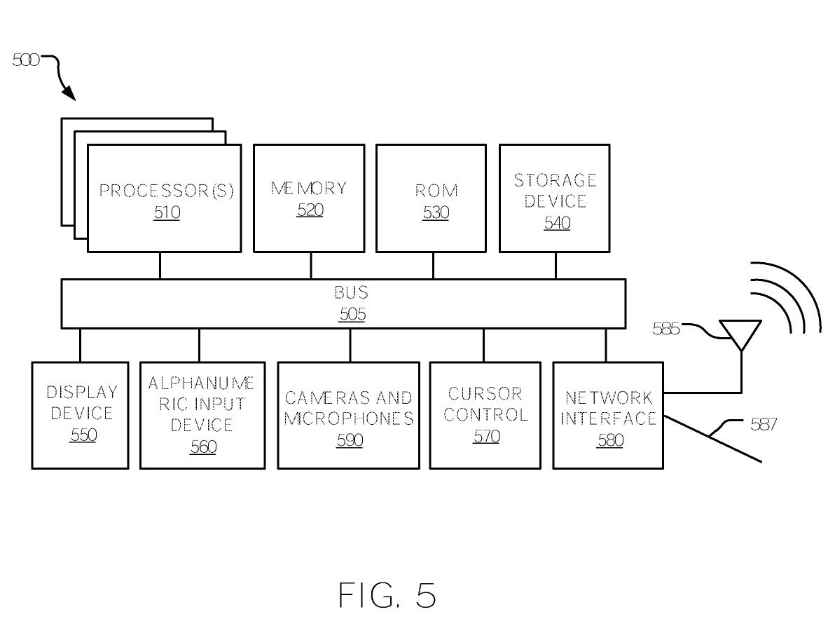

FIG. 5 illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

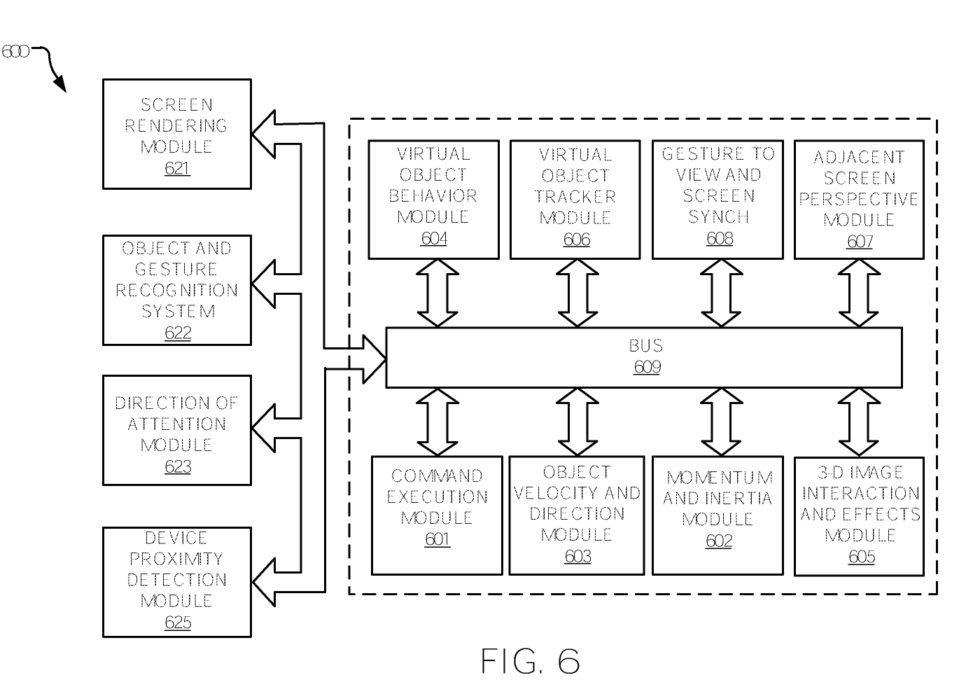

FIG. 6 illustrates an embodiment of a computing environment 600 capable of supporting the operations discussed above. The modules and systems can be implemented in a variety of different hardware architectures and form factors including that shown in FIG. 5.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers.

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays. As illustrated, various components, such as components 601, 602, 603, 604, 605. 606, 607, and 608 are connected via an interconnect or a bus, such as bus 609.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate flight management and control for unmanned aerial vehicles, the apparatus comprising: detection/monitoring logic to facilitate one or more sensors to detect an exclusion zone, wherein the exclusion zone includes a no-fly zone surrounding an entity including one or more of a real property, a personal property, and an individual; reception/verification logic to receive a signal from a broadcast beacon associated with the exclusion zone, wherein the signal includes a warning against entering the exclusion zone based a policy; and control/execution logic to automatically prevent the apparatus from entering the exclusion zone, wherein the control/execution logic to automatically perform at least one of landing the apparatus in a fly zone or pulling or turning the apparatus away from the exclusion zone.

Example 2 includes the subject matter of Example 1, wherein the apparatus comprises an unmanned aerial vehicle (UAV), wherein the UAV includes a drone.

Example 3 includes the subject matter of Example 1, wherein the broadcast beacon comprises a fixed broadcast beacon or a movable broadcast beacon, wherein the fixed broadcast beacon is capable of being installed or placed at the entity including the real property, wherein the movable broadcast beacon is capable being carried or worn by the entity including the individual or a vehicle.

Example 4 includes the subject matter of Example 1, wherein the policy comprises one or more of governmental laws, public regulations, organizational rules, and user preferences, wherein the policy is stored at a database.

Example 5 includes the subject matter of Example 1, wherein the control/execution logic to facilitate negotiation of the policy with the broadcast beacon to allow for access to the exclusion zone.

Example 6 includes the subject matter of Example 5, wherein if the negotiation is successful, the access to the exclusion zone is allowed based on restrictions or conditions, wherein the restrictions or conditions include one or more of time restrictions, altitude restrictions, distance restrictions, task conditions, and performance conditions.

Example 7 includes the subject matter of Example 5, wherein if the negotiation is unsuccessful, the access to the exclusion zone is denied and at least one of landing, pulling back, or turning away of the apparatus is executed.

Example 8 includes the subject matter of Example 1, further comprising: communication/interfacing logic to facilitate communication with at least one of the broadcast beacon and the database, wherein the communication/interfacing logic is further to provide interfacing with one or more computing devices accessible to one or more users; and compatibility/resolution logic to ensure compatibility with the one or more computing devices, and offer one or more resolutions to one or more of communication issues, compatibility issues, and interfacing issues.

Example 9 includes the subject matter of Example 8, wherein the one or more computing devices comprise a server computer capable of being facilitated to perform one or more of negotiating the policy, overriding flying plans associated with the apparatus, and receiving feedbacks relating to the exclusion zone, and wherein the one or more computing devices further comprise a pilot control device capable of being facilitated to perform basic operations relating to the apparatus, wherein the one or more users include an operator having access to the pilot control device.

Some embodiments pertain to Example 10 that includes a method for facilitating flight management and control for unmanned aerial vehicles, the method comprising: facilitating one or more sensors to detect an exclusion zone, wherein the exclusion zone includes a no-fly zone surrounding an entity including one or more of a real property, a personal property, and an individual; receiving a signal from a broadcast beacon associated with the exclusion zone, wherein the signal includes a warning against entering the exclusion zone based a policy; and automatically preventing a computing device from entering the exclusion zone, wherein preventing includes automatically performing at least one of landing the computing device in a fly zone or pulling or turning the computing device away from the exclusion zone.

Example 11 includes the subject matter of Example 10, wherein the computing device comprises an unmanned aerial vehicle (UAV), wherein the UAV includes a drone.

Example 12 includes the subject matter of Example 10, wherein the broadcast beacon comprises a fixed broadcast beacon or a movable broadcast beacon, wherein the fixed broadcast beacon is capable of being installed or placed at the entity including the real property, wherein the movable broadcast beacon is capable being carried or worn by the entity including the individual or a vehicle.

Example 13 includes the subject matter of Example 10, wherein the policy comprises one or more of governmental laws, public regulations, organizational rules, and user preferences, wherein the policy is stored at a database.

Example 14 includes the subject matter of Example 10, further comprising facilitating negotiation of the policy with the broadcast beacon to allow for access to the exclusion zone.

Example 15 includes the subject matter of Example 14, wherein if the negotiation is successful, the access to the exclusion zone is allowed based on restrictions or conditions, wherein the restrictions or conditions include one or more of time restrictions, altitude restrictions, distance restrictions, task conditions, and performance conditions.

Example 16 includes the subject matter of Example 14, wherein if the negotiation is unsuccessful, the access to the exclusion zone is denied and at least one of landing, pulling back, or turning away of the computing device is executed.

Example 17 includes the subject matter of Example 10, further comprising: facilitating communication with at least one of the broadcast beacon and the database, wherein facilitating communication includes providing interfacing with one or more computing devices accessible to one or more users; and ensuring compatibility with the one or more computing devices, and offering one or more resolutions to one or more of communication issues, compatibility issues, and interfacing issues.

Example 18 includes the subject matter of Example 17, wherein the one or more computing devices comprise a server computer capable of being facilitated to perform one or more of negotiating the policy, overriding flying plans associated with the computing device, and receiving feedbacks relating to the exclusion zone, and wherein the one or more computing devices further comprise a pilot control device capable of being facilitated to perform basic operations relating to the computing device, wherein the one or more users include an operator having access to the pilot control device.

Some embodiments pertain to Example 19 includes a system comprising a storage device having instructions, and a processor to execute the instructions to facilitate a mechanism to: facilitate one or more sensors to detect an exclusion zone, wherein the exclusion zone includes a no-fly zone surrounding an entity including one or more of a real property, a personal property, and an individual; receive a signal from a broadcast beacon associated with the exclusion zone, wherein the signal includes a warning against entering the exclusion zone based a policy; and automatically prevent a computing device from entering the exclusion zone, wherein preventing includes automatically performing at least one of landing the computing device in a fly zone or pulling or turning the computing device away from the exclusion zone.

Example 20 includes the subject matter of Example 19, wherein the computing device comprises an unmanned aerial vehicle (UAV), wherein the UAV includes a drone.

Example 21 includes the subject matter of Example 19, wherein the broadcast beacon comprises a fixed broadcast beacon or a movable broadcast beacon, wherein the fixed broadcast beacon is capable of being installed or placed at the entity including the real property, wherein the movable broadcast beacon is capable being carried or worn by the entity including the individual or a vehicle.

Example 22 includes the subject matter of Example 19, wherein the policy comprises one or more of governmental laws, public regulations, organizational rules, and user preferences, wherein the policy is stored at a database.

Example 23 includes the subject matter of Example 19, wherein the mechanism is further to facilitate negotiation of the policy with the broadcast beacon to allow for access to the exclusion zone.

Example 24 includes the subject matter of Example 23, wherein if the negotiation is successful, the access to the exclusion zone is allowed based on restrictions or conditions, wherein the restrictions or conditions include one or more of time restrictions, altitude restrictions, distance restrictions, task conditions, and performance conditions.

Example 25 includes the subject matter of Example 23, wherein if the negotiation is unsuccessful, the access to the exclusion zone is denied and at least one of landing, pulling back, or turning away of the computing device is executed.

Example 26 includes the subject matter of Example 19, wherein the mechanism is further to: facilitate communication with at least one of the broadcast beacon and the database, wherein facilitating communication includes providing interfacing with one or more computing devices accessible to one or more users; and ensure compatibility with the one or more computing devices, and offer one or more resolutions to one or more of communication issues, compatibility issues, and interfacing issues.

Example 27 includes the subject matter of Example 19, wherein the one or more computing devices comprise a server computer capable of being facilitated to perform one or more of negotiating the policy, overriding flying plans associated with the computing device, and receiving feedbacks relating to the exclusion zone, and wherein the one or more computing devices further comprise a pilot control device capable of being facilitated to perform basic operations relating to the computing device, wherein the one or more users include an operator having access to the pilot control device.

Some embodiments pertain to Example 28 includes an apparatus comprising: means for facilitating one or more sensors to detect an exclusion zone, wherein the exclusion zone includes a no-fly zone surrounding an entity including one or more of a real property, a personal property, and an individual; means for receiving a signal from a broadcast beacon associated with the exclusion zone, wherein the signal includes a warning against entering the exclusion zone based a policy; and means for automatically preventing a computing device from entering the exclusion zone, wherein preventing includes automatically performing at least one of landing the computing device in a fly zone or pulling or turning the computing device away from the exclusion zone.

Example 29 includes the subject matter of Example 28, wherein the computing device comprises an unmanned aerial vehicle (UAV), wherein the UAV includes a drone.

Example 30 includes the subject matter of Example 28, wherein the broadcast beacon comprises a fixed broadcast beacon or a movable broadcast beacon, wherein the fixed broadcast beacon is capable of being installed or placed at the entity including the real property, wherein the movable broadcast beacon is capable being carried or worn by the entity including the individual or a vehicle.

Example 31 includes the subject matter of Example 28, wherein the policy comprises one or more of governmental laws, public regulations, organizational rules, and user preferences, wherein the policy is stored at a database.

Example 32 includes the subject matter of Example 28, further comprising means for facilitating negotiation of the policy with the broadcast beacon to allow for access to the exclusion zone.

Example 33 includes the subject matter of Example 32, wherein if the negotiation is successful, the access to the exclusion zone is allowed based on restrictions or conditions, wherein the restrictions or conditions include one or more of time restrictions, altitude restrictions, distance restrictions, task conditions, and performance conditions.

Example 34 includes the subject matter of Example 32, wherein if the negotiation is unsuccessful, the access to the exclusion zone is denied and at least one of landing, pulling back, or turning away of the computing device is executed.

Example 35 includes the subject matter of Example 28, further comprising: means for facilitating communication with at least one of the broadcast beacon and the database, wherein the means for facilitating communication includes means for providing interfacing with one or more computing devices accessible to one or more users; and means for ensuring compatibility with the one or more computing devices, and means for offering one or more resolutions to one or more of communication issues, compatibility issues, and interfacing issues.

Example 36 includes the subject matter of Example 28, wherein the one or more computing devices comprise a server computer capable of being facilitated to perform one or more of negotiating the policy, overriding flying plans associated with the computing device, and receiving feedbacks relating to the exclusion zone, and wherein the one or more computing devices further comprise a pilot control device capable of being facilitated to perform basic operations relating to the computing device, wherein the one or more users include an operator having access to the pilot control device.

Example 37 includes at least one non-transitory machine-readable medium comprising a plurality of instructions, when executed on a computing device, to implement or perform a method as claimed in any of claims or examples 10-18.

Example 38 includes at least one machine-readable medium comprising a plurality of instructions, when executed on a computing device, to implement or perform a method as claimed in any of claims or examples 10-18.

Example 39 includes a system comprising a mechanism to implement or perform a method as claimed in any of claims or examples 10-18.

Example 40 includes an apparatus comprising means for performing a method as claimed in any of claims or examples 10-18.

Example 41 includes a computing device arranged to implement or perform a method as claimed in any of claims or examples 10-18.

Example 42 includes a communications device arranged to implement or perform a method as claimed in any of claims or examples 10-18.

Example 43 includes at least one machine-readable medium comprising a plurality of instructions, when executed on a computing device, to implement or perform a method or realize an apparatus as claimed in any preceding claims or examples.

Example 44 includes at least one non-transitory machine-readable medium comprising a plurality of instructions, when executed on a computing device, to implement or perform a method or realize an apparatus as claimed in any preceding claims or examples.

Example 45 includes a system comprising a mechanism to implement or perform a method or realize an apparatus as claimed in any preceding claims or examples.

Example 46 includes an apparatus comprising means to perform a method as claimed in any preceding claims or examples.

Example 47 includes a computing device arranged to implement or perform a method or realize an apparatus as claimed in any preceding claims or examples.

Example 48 includes a communications device arranged to implement or perform a method or realize an apparatus as claimed in any preceding claims or examples.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
detection/monitoring logic to facilitate one or more sensors to detect an exclusion zone, wherein the exclusion zone includes a no-fly zone surrounding an entity including one or more of a real property, a personal property, and an individual;
reception/verification logic to receive a signal from a broadcast beacon associated with the exclusion zone, wherein the signal includes a warning against entering the exclusion zone based a policy; and
control/execution logic to automatically prevent the apparatus from entering the exclusion zone, wherein the control/execution logic to automatically perform at least one of landing the apparatus in a fly zone or pulling or turning the apparatus away from the exclusion zone.

2. The apparatus of claim 1, wherein the apparatus comprises an unmanned aerial vehicle (UAV), wherein the UAV includes a drone.

3. The apparatus of claim 1, wherein the broadcast beacon comprises a fixed broadcast beacon or a movable broadcast beacon, wherein the fixed broadcast beacon is capable of being installed or placed at the entity including the real property, wherein the movable broadcast beacon is capable being carried or worn by the entity including the individual or a vehicle.

4. The apparatus of claim 1, wherein the policy comprises one or more of governmental laws, public regulations, organizational rules, and user preferences, wherein the policy is stored at a database.

5. The apparatus of claim 1, wherein the control/execution logic to facilitate negotiation of the policy with the broadcast beacon to allow for access to the exclusion zone.

6. The apparatus of claim 5, wherein if the negotiation is successful, the access to the exclusion zone is allowed based on restrictions or conditions, wherein the restrictions or conditions include one or more of time restrictions, altitude restrictions, distance restrictions, task conditions, and performance conditions.

7. The apparatus of claim 5, wherein if the negotiation is unsuccessful, the access to the exclusion zone is denied and at least one of landing, pulling back, or turning away of the apparatus is executed.

8. The apparatus of claim 1, further comprising:
communication/interfacing logic to facilitate communication with at least one of the broadcast beacon and the database, wherein the communication/interfacing logic is further to provide interfacing with one or more computing devices accessible to one or more users; and
compatibility/resolution logic to ensure compatibility with the one or more computing devices, and offer one or more resolutions to one or more of communication issues, compatibility issues, and interfacing issues.

9. The apparatus of claim 8, wherein the one or more computing devices comprise a server computer capable of being facilitated to perform one or more of negotiating the policy, overriding flying plans associated with the apparatus, and receiving feedbacks relating to the exclusion zone, and wherein the one or more computing devices further comprise a pilot control device capable of being facilitated to perform basic operations relating to the apparatus, wherein the one or more users include an operator having access to the pilot control device.

10. A method comprising:
facilitating one or more sensors to detect an exclusion zone, wherein the exclusion zone includes a no-fly zone surrounding an entity including one or more of a real property, a personal property, and an individual;
receiving a signal from a broadcast beacon associated with the exclusion zone, wherein the signal includes a warning against entering the exclusion zone based a policy; and
automatically preventing a computing device from entering the exclusion zone, wherein preventing includes automatically performing at least one of landing the computing device in a fly zone or pulling or turning the computing device away from the exclusion zone.

11. The method of claim 10, wherein the computing device comprises an unmanned aerial vehicle (UAV), wherein the UAV includes a drone.

12. The method of claim 10, wherein the broadcast beacon comprises a fixed broadcast beacon or a movable broadcast beacon, wherein the fixed broadcast beacon is capable of being installed or placed at the entity including the real property, wherein the movable broadcast beacon is capable being carried or worn by the entity including the individual or a vehicle.

13. The method of claim 10, wherein the policy comprises one or more of governmental laws, public regulations, organizational rules, and user preferences, wherein the policy is stored at a database.

14. The method of claim 10, further comprising facilitating negotiation of the policy with the broadcast beacon to allow for access to the exclusion zone.

15. The method of claim 14, wherein if the negotiation is successful, the access to the exclusion zone is allowed based on restrictions or conditions, wherein the restrictions or conditions include one or more of time restrictions, altitude restrictions, distance restrictions, task conditions, and performance conditions.

16. The method of claim 14, wherein if the negotiation is unsuccessful, the access to the exclusion zone is denied and at least one of landing, pulling back, or turning away of the computing device is executed.

17. The method of claim 10, further comprising:
facilitating communication with at least one of the broadcast beacon and the database, wherein facilitating communication includes providing interfacing with one or more computing devices accessible to one or more users; and
ensuring compatibility with the one or more computing devices, and offering one or more resolutions to one or more of communication issues, compatibility issues, and interfacing issues.

18. The method of claim 17, wherein the one or more computing devices comprise a server computer capable of being facilitated to perform one or more of negotiating the policy, overriding flying plans associated with the computing device, and receiving feedbacks relating to the exclusion zone, and wherein the one or more computing devices further comprise a pilot control device capable of being facilitated to perform basic operations relating to the computing device, wherein the one or more users include an operator having access to the pilot control device.

19. At least one machine-readable medium comprising instructions which, when executed by a computing device, cause the computing device to:
facilitate one or more sensors to detect an exclusion zone, wherein the exclusion zone includes a no-fly zone surrounding an entity including one or more of a real property, a personal property, and an individual;
receive a signal from a broadcast beacon associated with the exclusion zone, wherein the signal includes a warning against entering the exclusion zone based a policy; and
automatically prevent the computing device from entering the exclusion zone, wherein preventing includes automatically performing at least one of landing the computing device in a fly zone or pulling or turning the computing device away from the exclusion zone.

20. The machine-readable medium of claim 19, wherein the computing device comprises an unmanned aerial vehicle (UAV), wherein the UAV includes a drone.

21. The machine-readable medium of claim 19, wherein the broadcast beacon comprises a fixed broadcast beacon or a movable broadcast beacon, wherein the fixed broadcast beacon is capable of being installed or placed at the entity including the real property, wherein the movable broadcast beacon is capable being carried or worn by the entity including the individual or a vehicle.

22. The machine-readable medium of claim 19, wherein the policy comprises one or more of governmental laws, public regulations, organizational rules, and user preferences, wherein the policy is stored at a database.

23. The machine-readable medium of claim 19, wherein the computing device is further to facilitate negotiation of the policy with the broadcast beacon to allow for access to the exclusion zone,
wherein if the negotiation is successful, the access to the exclusion zone is allowed based on restrictions or conditions, wherein the restrictions or conditions include one or more of time restrictions, altitude restrictions, distance restrictions, task conditions, and performance conditions,
wherein if the negotiation is unsuccessful, the access to the exclusion zone is denied and at least one of landing, pulling back, or turning away of the computing device is executed.

24. The machine-readable medium of claim 19, wherein the computing device is further to:
facilitate communication with at least one of the broadcast beacon and the database, wherein facilitating communication includes providing interfacing with one or more computing devices accessible to one or more users; and
ensure compatibility with the one or more computing devices, and offer one or more resolutions to one or more of communication issues, compatibility issues, and interfacing issues.

25. The machine-readable medium of claim 24, wherein the one or more computing devices comprise a server computer capable of being facilitated to perform one or more of negotiating the policy, overriding flying plans associated with the computing device, and receiving feedbacks relating to the exclusion zone, and wherein the one or more computing devices further comprise a pilot control device capable of being facilitated to perform basic operations relating to the computing device, wherein the one or more users include an operator having access to the pilot control device.
